(19) United States
(12) Patent Application Publication
(10) Pub. No.: US 2025/0306241 A1
(43) Pub. Date: Oct. 2, 2025

(54) LOCALIZED HEAT STRESS ANALYSIS AND REAL-TIME ENVIRONMENTAL ADAPTATION

(71) Applicant: Klimo Insights LLC, Durham, NC (US)

(72) Inventor: Jordan Clark, Durham, NC (US)

(21) Appl. No.: 18/672,940

(22) Filed: May 23, 2024

Related U.S. Application Data
(60) Provisional application No. 63/569,932, filed on Mar. 26, 2024.

(51) Int. Cl. G01W 1/10; G01W 1/06

(52) U.S. Cl. CPC G01W 1/10; G01W 1/06

(57) ABSTRACT

Some embodiments of the present disclosure provide inventive concepts for estimating a value for an environmental heat stress index at a target microscale location. Meteorological data indicative of parameters such as relative humidity, air temperature, wind characteristics, or atmospheric cloud cover for a geographic area representative of a larger geographic area that includes the target microscale location can be obtained. Localized terrain data specific to the target microscale location can be obtained. A bias correction can be performed on the meteorological data based on the localized terrain data, generating microscale meteorological data that reflects conditions at the target microscale location. The heat stress index value, representing heat-related risk specific to the target microscale location, can be determined using the microscale meteorological data and can be a real-time or forecast value used for providing actionable insights or alerts for health and safety purposes.

### RELATED APPLICATIONS

Any and all applications for which a foreign or domestic priority claim is identified in the Application Data Sheet as filed with the present application are incorporated by reference under 37 CFR 1.57 and made a part of this specification. This application claims priority to U.S. Provisional Patent Application No. 63/569,932, entitled “Enhanced Environmental Monitoring and Heat Stress Prediction Through Advanced Data Analysis,” filed Mar. 26, 2024, which is hereby incorporated by reference in its entirety.

### FIELD

The present disclosure generally relates to environmental monitoring and public health, and, more particularly, to assessing and predicting localized heat stress conditions using meteorological data analysis.

### BACKGROUND

Heat stress is an environmental and occupational hazard that poses a significant risk to human health and productivity. It occurs when the body is unable to sufficiently cool itself and maintain a healthy temperature. Various industries and sectors, such as construction, agriculture, sports, outdoor events, and others are particularly susceptible to the impacts of heat stress, which can lead to serious health consequences, including heat stroke, dehydration, and exacerbation of existing health conditions.

The Wet Bulb Globe Temperature (WBGT) index is widely recognized as a reliable indicator for evaluating potential heat stress or offering guidance on the level of activity and rest periods required for individuals working or engaging in activities in direct sunlight. It is an environmental index that has been developed to quantify the risk of heat-related stress, which takes into account temperature, humidity, wind speed, sun angle, and cloud cover (solar radiation). These factors combine to provide a composite temperature believed to represent the thermal environment's effect on the individual.

Traditional methods for measuring the WBGT often rely on specialized meteorological equipment that can be costly to acquire and operate. The expense often extends to the need for specialized expertise to interpret the data accurately. Many organizations face budget constraints that prevent them from accessing these high-quality tools and the necessary skilled personnel, which can compromise the accuracy of the data collected. Furthermore, WBGT is often estimated from non-proximate sources, such as airport weather stations or specific locations within a broader area (e.g., only the baseball field on a high school campus), which inherently fail to capture and account for the variations in weather conditions in localized zones or meet the unique needs of different activities.

### SUMMARY

Some embodiments of the present disclosure provide inventive concepts for estimating a value for an environmental heat stress index at a target microscale location. Meteorological data indicative of parameters such as relative humidity, air temperature, wind characteristics, or atmospheric cloud cover for a geographic area representative of a larger geographic area that includes the target microscale location can be obtained. Localized terrain data specific to the target microscale location can be obtained. A bias correction can be performed on the meteorological data based on the localized terrain data, generating microscale meteorological data that reflects conditions at the target microscale location. The heat stress index value, representing heat-related risk specific to the target microscale location, can be determined using the microscale meteorological data and can be a real-time or forecast value used for providing actionable insights or alerts for health and safety purposes.

### BRIEF DESCRIPTION OF THE DRAWINGS

Throughout the drawings, reference numbers can be re-used to indicate correspondence between referenced elements. The drawings are provided to illustrate embodiments of the present disclosure and do not to limit the scope thereof.

FIG. 1 illustrates an example environment in accordance with some embodiments of the present disclosure.

FIG. 2 illustrates an example block diagram for an example environmental monitoring and/or forecasting system.

FIG. 3 illustrates a geographic representation of various meteorological data systems in relation to a target microscale location, in accordance with some embodiments of the present disclosure.

FIG. 4 is a flow diagram illustrative of an embodiment of a routine for generating a forecast of environmental heat stress for a target microscale location.

FIG. 5 is a flow diagram illustrative of an embodiment of a routine for determining current values of environmental heat stress for a target microscale location.

FIG. 6 is a flow diagram illustrative of an embodiment of a routine for generating localized terrain data for environmental condition modeling.

### DETAILED DESCRIPTION

The Wet Bulb Globe Temperature (WBGT) index is an established metric for evaluating heat stress, incorporating environmental parameters such as temperature, humidity, wind speed, and solar radiation. Two primary formulas are employed to calculate WBGT, varying based on whether measurements are taken indoors or outdoors:

$${WBGT}_{outdorr} = 0.7 {T}_{w} + 0.2 {T}_{g} + 0.1 {T}_{d} \qquad ( Equation 1 )$$

$${WBGT}_{indoor} = 0.7 {T}_{w} + 0.3 {T}_{g} \qquad ( Equation 2 )$$

where T_{w} where is Natural Wet Bulb Temperature, indicating cooling effects through evaporation and simulating the physiological impact of sweating; T_{g} is Globe temperature, capturing solar and infrared radiation using a black globe thermometer; and T_{d} is Dry Bulb Temperature, representing the ambient air temperature.

The WBGT (Wet Bulb Globe Temperature) often reflects average conditions over wide areas because the data used for its calculation typically represents large geographic regions rather than specific, localized locations. For example, meteorological stations and weather networks commonly provide regional readings that are often spaced far apart and do not account for local microclimates. As a result, WBGT measurements may not capture localized heat stress at smaller sites, such as sports fields, construction zones, or outdoor event areas, without direct measurement onsite or adjustment for microvariations.

Achieving precise WBGT estimates on a microscale presents numerous challenges due to the variability in local environmental conditions and microclimatic factors. These factors can include, but are not limited to, diversity in land cover, the presence or absence of varied surface types such as asphalt or grass (e.g., urban developments, water bodies, vegetation, etc.); topography and elevation changes; built structures and their influence on airflow and solar exposure; or the presence or absence of water bodies that influence humidity.

Traditional methods to obtain estimates on the microscale often rely on direct onsite measurements but can encounter practical difficulties, including the need for substantial time investments, specialized expertise, and sophisticated equipment. The variability in environmental conditions and microclimatic influences contributes to significant spatial and temporal discrepancies, limiting the ability to make informed decisions regarding heat stress or heat strain management at the microscale level. Given these considerations, there is a need for innovative approaches that refine the process of estimating WBGT at the microscale.

To address these and other challenges, some inventive concepts herein enhance microscale forecasting by integrating localized terrain information with broader weather forecast data. This integration refines general weather predictions by incorporating specific local details such as vegetation cover, surface typologies, surface roughness, and factors related to and resultant from the built environment, resulting in bias-corrected data for improved accuracy at a micro level (e.g., tens to hundreds of meters). By including localized terrain information, the resultant data can be tailored to accurately reflect the unique climatic conditions of a target microscale location, such as a sports field, construction site, or festival grounds. These techniques can at least partially correct inherent biases in general forecasts, which typically represent a larger geographic area that includes or is proximate to the target microscale location, thereby producing predictions that are more precise and directly relevant to the target microscale location.

Some inventive concepts described herein utilize microscale forecast data to generate a tailored forecast for an environmental heat stress index at a specific microscale location. This forecasted index, which can include metrics such as the Wet Bulb Globe Temperature (WBGT) or its constituent components, the natural wet bulb temperature and/or the black globe temperature, can reflect factors such as temperature, humidity, wind speed, sun angle, and cloud cover to assess potential heat-related risks. This forecast value represents a predicted heat-related risk that individuals might experience at a future time at the target microscale location. Such forecasting facilitates precise predictions of heat-related risks and supports the implementation of targeted preventive measures, thereby enhancing safety and health management at these finely specified locations. Furthermore, accurate calculation of natural wet bulb temperature can be beneficial, as it addresses common issues in the sector where it is often miscalculated by being equated with psychrometric wet bulb temperature.

Some inventive concepts described herein utilize microscale environmental data to generate a current assessment of an environmental heat stress index at a specific microscale location. This current heat stress index can reflect real-time factors such as temperature, humidity, wind speed, sun angle, and cloud cover to assess potential heat-related risks. This current value represents the immediate heat-related risk that individuals might experience at the target microscale location. Such real-time assessment facilitates immediate decision-making and supports the implementation of targeted preventive measures, thereby enhancing safety and health management at these finely specified locations.

The techniques described herein not only improve the accuracy and reliability of heat stress assessments in specific, localized settings but also strengthen overall strategies for monitoring and mitigating heat-related risks.

Although heat stress is generally discussed herein, the techniques described are applicable to heat strain as well. Heat strain refers to the body's response to heat stress (environmental conditions). In some cases, the disclosed system can be configured to allow users to input additional information, such as physiological data (e.g., height, weight, age, prescription medications), to further tailor heat risk assessments to the individual level. This additional user-contributed data can enhance the app's ability to provide personalized heat risk predictions.

For purposes of this disclosure, the term “microscale” generally refers to a spatial parameter at the localized level, distinguishing it from broader geographic metrics like zip codes, towns, counties, or metropolitan areas. A microscale area, sometimes referred to as a target microscale location, can encompass spaces ranging from less than a quarter or half an acre, up to tens or hundreds of acres or multiple square miles. For example, target microscale locations can include sports fields, sports complexes, construction sites, sections of outdoor events, parks, small or medium parking lots, city blocks, rooftops, plazas, or the like. In terms of square miles, a target microscale location can range from fractions of a square mile to several square miles, covering areas such as neighborhoods, districts, campuses, or larger urban parks.

In some cases, the Natural Wet Bulb Temperature (NWB) can be estimated using Equation 3:

$${T}_{nwb} = - 429.0358 + 11.06136 \cdot {T}_{a} + 3.680584 \cdot RH - 0.006299761 \cdot S - 0.1871908 \cdot WS - 0.05325034 \cdot {T}_{d} + 0.08313516 \cdot {T}_{g} + 2.830688 \cdot e - 0.06283954 \cdot {T}_{a}^{2} - 0.05983947 \cdot ( {T}_{a} \cdot RH ) + 0.00005748439 \cdot ( {T}_{a} \cdot S ) + 0.00001971545 \cdot ( RH \cdot S ) \qquad ( Equation 3 )$$

where Tₐ represents the Air Temperature in degrees Fahrenheit (° F.); RH represents Relative Humidity as a percentage (%); S is the Solar Radiation measured in watts per square meter (W/m²); WS represents Wind Speed in miles per hour (mph); T_{d} represents the Dew Point Temperature in degrees Fahrenheit (° F.); T_{g} represents the Globe Temperature in degrees Fahrenheit (° F.); and e refers to the Vapor Pressure in kilopascals (kPa).

### Classifying Cloud Types and Thickness

To classify cloud types and thickness, several criteria can be used based on temperature measurements from specific channels.

For cloud moisture classification, the brightness temperature (Tch3) in Channel 3 (GOES 12 Band 3) and/or GOES 16 channel 13 can be used. High Moisture can be indicated if Tch is less than 220 K. Medium Moisture can be indicated if Tch is between 220 and 240 K. Low Moisture can be indicated if Tch is greater than 240 K.

Cloud height classification can use the temperature (Tch) from channel 3 (GOES 12) or channel 13 (Goes 16). High clouds can be classified if Tch is less than 215 K. Middle clouds can be classified if Tch is between 215 and 235 K. Low clouds can be classified if Tch is greater than 235 K.

For cloud thickness classification, the brightness temperature from GOES 12 channel 4 or GOES 16 channel 14 can be used. Dense clouds can be classified if Tch4 is less than 233 K. Thick clouds can be classified if Tch4 is between 233 and 253 K. Moderate clouds can be classified if Tch4 is between 253 and 273 K. Thin clouds can be classified if Tch4 is greater than 273 K. Additional classification may be supplemented from the cloud optical depth obtained from GOES 16 satellite imagery.

Cloud type classification based on Channel 4 (GOES 12) or Channel 14 (GOES 16) brightness temperature can be as follows: Thick Clouds can be indicated if Tch4 is less than 230 K. High Clouds can be indicated if Tch4 is between 230 and 250 K. Low Clouds can be indicated if Tch4 is between 250 and 270 K. Very Low Clouds can be indicated if Tch4 is greater than 270 K. Additional classification may be supplemented from the cloud optical depth obtained from GOES 16 satellite imagery.

### Cloud Cover Adjustment of Solar Radiation

To adjust solar radiation for cloud cover, several variables and steps can be considered.

The variables can include, but are not limited to, the Solar Elevation Angle (θ) in degrees, Solar Elevation Angle (θ_{rad}) in radians, Clear-sky Solar Radiation (R₀) measured in W/m², Low Cloud Cover (lcdc) as a fraction, Medium Cloud Cover (mcdc) as a fraction, High Cloud Cover (hcdc) as a fraction, Total Cloud Cover (tcdc) as a fraction, Decay Factor (df), which is dimensionless and constant at 3.5, and Higher Cloud Effect (hce), which is dimensionless and constant at 7.

The solar radiation (RR) adjusted for cloud cover can be calculated through the following steps:

### Step 1: Solar Elevation Calculation

$$θ = 90 - \text{?} \qquad ( Equation 4 )$$

$${θ}_{rad} = θ \times \frac{π}{180}$$

$$\text{?} \text{indicates text missing or illegible when filed}$$

### Step 2: Clear-Sky Solar Radiation

$${R}_{0} = 990 \times sin ( {θ}_{rad} - 30 ) \qquad ( Equation 5 )$$

### Step 3: Adjustment Based on Cloud Cover

If only total cloud cover data is available:

$$R = {R}_{0} \times ( 1 - ( 0.75 \times ( {lcdc}^{3.4} ) + 0.5 \times ( {mcdc}^{3.4} ) + 0.25 \times ( {hcdc}^{3.4} ) ) ) \qquad ( Equation 6 )$$

If only total cloud cover data is available:

$$R = {R}_{0} \times exp ( - df \times ( {tcdc}^{hce} ) ) \qquad ( Equation 7 )$$

In step 4, decision rules for cloud cover adjustments and solar radiation adjustments can be applied.

The Total Cloud Cover (TCDC) can be defined as follows:

TCDC is set to 100 if the cloud thickness, derived from Tch4, is Dense and initial TCDC provided from weather forecast model is greater than 75, and if the forecast model does not provide the total cloud cover parameter or it is unavailable. TCDC is set to adj2 if the cloud thickness, derived from Tch4, is Thick, the cloud height, derived from Tch3, is High or Middle, and if the forecast model does not provide the total cloud cover parameter or it is unavailable, where: adj2=min (TCDC+0.25×TCDC, 100).

If the weather forecast model provides a direct shortwave radiation parameter (dswrf) and the following conditions are met, that value can be used. Otherwise, it can be modified as: dswrf can be used if the moisture content, derived from Tch3, is Medium Moisture or Low Moisture, the cloud height, derived from Tch4, is Very Low or Low, and the derived cloud thickness from Tch4 is not Moderate; Otherwise, the solar radiation is set to R derived from Equation 7.

### Environment Overview

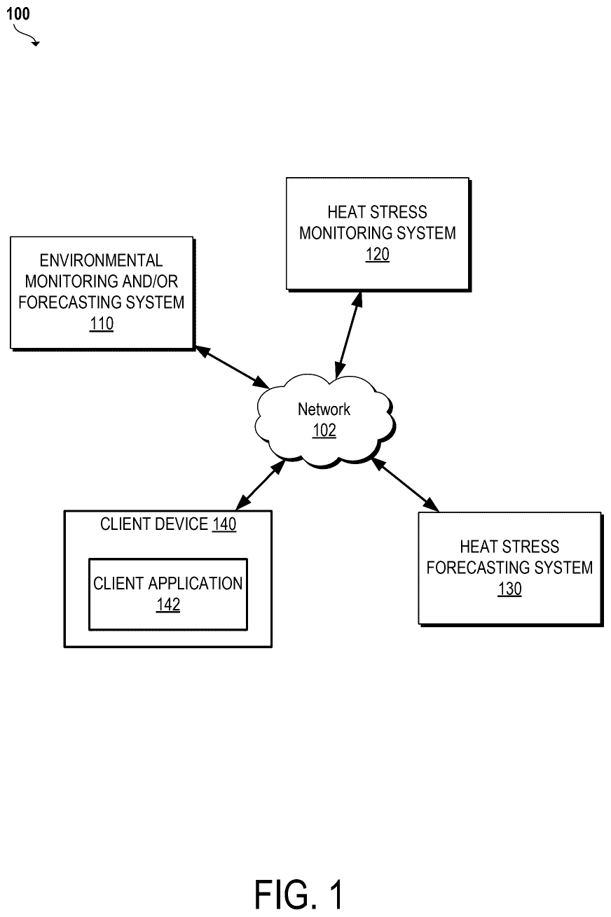

FIG. 1 illustrates an example environment 100 in accordance with some embodiments of the present disclosure. The environment 100 includes an environmental monitoring and/or forecasting system 110, a data store 112, a heat stress monitoring system 120, a heat stress forecasting system 130, a client device 140, and a client application 142. It will be appreciated that the environment 100 can include fewer, more, or different components, as desired. For example, to simplify discussion and not to limit the present disclosure, FIG. 1 illustrates only one environmental monitoring and/or forecasting system 110, data store 112, heat stress monitoring system 120, heat stress forecasting system 130, client device 140, and client application 142, though multiple may be included in the environment 100.

Any of the foregoing components or systems of the environment 100 may communicate via the network 102. Although only one network 102 is illustrated, multiple distinct and/or distributed networks 102 may exist. The network 102 can include any type of communication network. For example, the network 102 can include one or more of a wide area network (WAN), a local area network (LAN), a cellular network, an ad hoc network, a satellite network, a wired network, a wireless network, and so forth. In some embodiments, the network 102 can include the Internet.

Any of the foregoing components or systems of the environment 100, such as any one or any combination of the environmental monitoring and/or forecasting system 110, the data store 112, the heat stress monitoring system 120, the heat stress forecasting system 130, or the client device 140 may be implemented using individual computing devices, processors, distributed processing systems, servers, isolated execution environments (e.g., virtual machines, containers, etc.), shared computing resources, or so on. Furthermore, any of the foregoing components or systems of the environment 100 may host or execute one or more client applications (e.g., client application 142), which may include a web browser, a mobile application, a background process that performs various operations with or without direct interaction from a user, or a “plug-in” or “extension” to another application, such as a web browser plug-in or extension.

The environmental monitoring and forecasting system 110 is responsible for obtaining, storing, analyzing, and presenting environmental and forecast data. The environmental monitoring and forecasting system 110 can include a network of sensors, meteorological models, or databases that collectively gather information on weather conditions, heat levels, atmospheric factors, or the like. For example, the environmental monitoring and forecasting system 110 may interface with or include one or more meteorological platforms, such as the National Centers for Environmental Prediction (NCEP) Operational Model Archive and Distribution System (NOMADS), the Global Forecast System (GFS), the North American Model (NAM), or the High-Resolution Rapid Refresh (HRRR) model. These models are frequently updated and include current environmental data that reflect immediate weather conditions from various observation tools like weather stations, aircraft, radar, and satellites, including GOES, MODIS, and Sentinel 2A. The satellites can provide detailed imagery on cloud cover, radiance, and other atmospheric parameters.

The heat stress monitoring system 120 can be employed for determining a current value for an environmental heat stress index at a target microscale location. The heat stress monitoring system 120 can obtain environmental data, which can include parameters related to current, historical, or forecast meteorological and environmental conditions. For example, the environmental data can include, but is not limited to, parameters relating to relative humidity, air temperature, wind characteristics, atmospheric cloud cover, or terrain data. The environmental data can be acquired from multiple sources, including, but not limited to, the environmental monitoring and forecasting system 110, direct observations, sensor data gathered from handheld or onsite devices (such as drones), or imagery depicting meteorological and environmental conditions.

The environmental data can include generalized and/or localized information. Generalized data can represent large geographic regions or reflect average conditions over wide areas, offering an overview of regional trends or averages. In contrast, localized or microscale data can provide specific insights for particular geographic areas, capturing microclimate characteristics or other localized environmental conditions. In some cases, the microscale data includes localized terrain data. The localized data can be sourced from at least one of the following: a Geographic Information System (GIS) that integrates layers of data representing urban structures, terrain features, or vegetation; satellite imagery or aerial photography that provide information on land cover or urban development; topographic maps or surveys conducted by national or regional mapping agencies that detail contours, elevations, or specific landscape features; environmental sensors deployed in the designated location (e.g., onsite instrument 330) that gather real-time or periodic data on soil conditions, vegetation health, or urban heat islands; or local observations.

The heat stress monitoring system 120 can perform a bias correction on the environmental data using localized information to correct for bias in the generalized information. In this context, bias can refer to systematic discrepancies between generalized environmental data and actual conditions at the target microscale location due to varying geographic and meteorological factors. In some cases, the bias correction correct for factors such as, but not limited to, wind speed, boundary layer mixing, humidity, surface type, radiant temperature, or radiative influences from varying surfaces relevant to the target microscale location. Correcting for this bias can help ensure that the data more accurately reflects the specific conditions of the localized area, leading to more precise assessments.

The heat stress monitoring system 120 can leverage the corrected environmental data to calculate a current Wet Bulb Globe Temperature (WBGT) value, thereby reflecting current heat stress conditions at the target microscale location.

The heat stress forecasting system 130 can be employed for predicting a future value (i.e., forecasting) for an environmental heat stress index at a target microscale location. Similar to the heat stress monitoring system 120, the heat stress forecasting system 130 can obtain environmental data, such as from the environmental monitoring and forecasting system 110, the heat stress forecasting system 130, user-contributed data, onsite instruments, or the like.

Similar to the heat stress monitoring system 120, the heat stress forecasting system 130 can perform a bias correction on the environmental data using localized information to correct for bias in the generalized information. In some cases, the bias correction correct for factors such as, but not limited to, wind speed, boundary layer mixing, and humidity relevant to the target microscale location. Correcting for this bias can help ensure that the data more accurately reflects the specific conditions of the localized area, leading to more precise assessments.

The heat stress forecasting system 130 can leverage the corrected environmental data to calculate a forecasted Wet Bulb Globe Temperature (WBGT) value. Such a calculation can reflect the anticipated heat stress conditions at the target microscale location.

In some cases, the forecasting utilizes sophisticated models that draw on data from multiple sensors at varying altitudes. For example, parameters such as solar radiation and wind dynamics at different altitudes can be determined, with adjustments based on localized terrain data and/or cloud coverage data. In some cases, correcting biases can include making changing related to wind dynamics, atmospheric stratification, moisture content, or surface typologies using machine learning algorithms.

The client application 142 may facilitate user interaction with the environmental monitoring and forecasting system 110, the heat stress monitoring system 120, and/or the heat stress forecasting system 130 by providing a dynamic interface. For example, the client application 142 may provide an interface through which a user can access current environmental data (e.g., current values for an environmental heat stress index) and forecasted environmental data (e.g., forecast values for an environmental heat stress index), or receive alerts about unsafe conditions. In some cases, the client application 142 can provide an interface with which users can input or select specific parameters for customized data analysis. For instance, users can specify a target microscale location or a desired forecast date and time.

In some cases, the client application 142 allows users to input user-contributed data regarding actual environmental conditions at the target microscale location, such as taking a photo or inputting measurements. In this way, the client application 142 can improve accuracy by integrating ground-level data with broader environmental monitoring. In some such cases, the client application 142 (along with various components of the environment 100) can adjust monitoring and forecasting settings based on user input and notify users of deviations in the environmental heat stress index relative to established thresholds over a defined monitoring period. In this way, the client application 142 and the other components of the environment 100 can enhance personalized decision-making and improve responsiveness to changing heat stress conditions, ensuring that users are well-informed and able to act promptly to mitigate risks.

In some cases, the user-contributed data can be physiological data, such as height, weight, age, body mass index (BMI), hydration levels, heart rate, or information about prescription medications. This data can allow the client application 142 to further tailor heat risk assessments to the individual level, providing personalized heat risk predictions. Furthermore, these techniques can be applied to both heat stress and heat strain, enhancing the ability of the client application 142 to predict the body's response to environmental heat conditions and improve user safety.

The client application 142 may include a web browser, a mobile application or “app,” a background process that performs various operations with or without direct interaction from a user, or a “plug-in” or “extension” to another application, such as a web browser plug-in or extension. Although FIG. 1 illustrates the client application 142 as being implemented on the client device 140, it will be understood that any of the components or systems of the environment 100 may host, execute, or interact with the client application 142. Furthermore, in some cases, the client application 142 may be hosted or executed by one or more host devices (not shown), which may broadly include any number of computers, virtual machine instances, and/or data centers that are configured to host or execute one or more instances of the client application 142.

The client device 140 represents any computing device capable of interacting with or running the client application 142. Examples of client devices 140 may include, without limitation, smart phones, tablet computers, handheld computers, wearable devices, laptop computers, desktop computers, servers, portable media players, gaming devices, and so forth.

Environmental Monitoring and/or Forecasting System

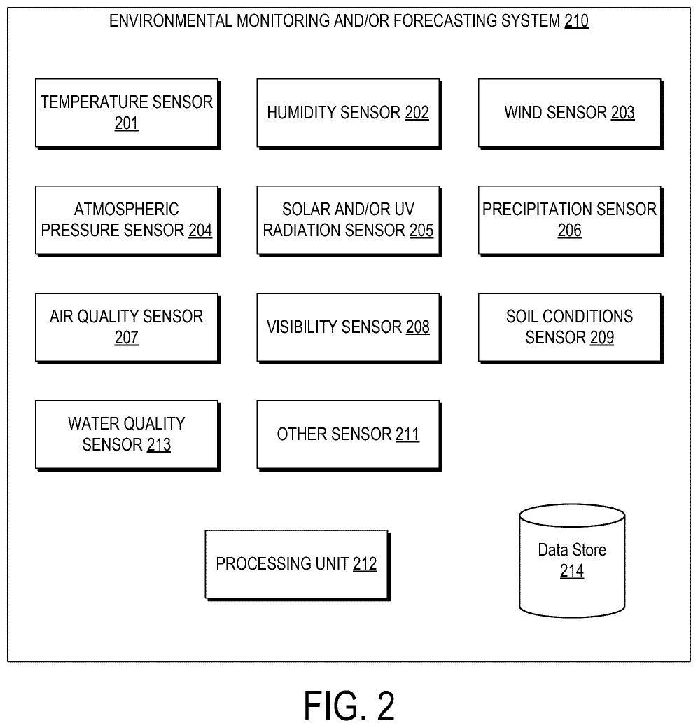

FIG. 2 illustrates an example block diagram for an example environmental monitoring and/or forecasting system 210, which may be an embodiment of the environmental monitoring and/or forecasting system 110 of FIG. 1. As described herein, the environmental monitoring and/or forecasting system 210 can include or be in communication with a variety of components and/or subsystems configured to collect, store, analyze, and/or forecast environmental data to facilitate accurate monitoring and/or prediction of atmospheric conditions.

The environmental monitoring and/or forecasting system 210 can include one or more sensors or measurement devices tailored for environmental assessment. For example, the environmental monitoring and/or forecasting system 210 can include, but is not limited to, temperature sensors 201 for measuring air, surface, and/or water temperatures; humidity sensors 202 to determine relative humidity and/or dew point; wind sensors 203 (e.g., anemometers for assessing wind speed and direction); atmospheric pressure sensors 204 (e.g., barometers); solar and/or ultraviolet (UV) radiation sensors 205; precipitation sensors 206 (e.g., rain gauges for tracking precipitation); or air quality sensors 207 to detect pollutants such as particulate matter, ozone, carbon monoxide, and nitrogen dioxide. Additional sensors can include visibility sensors 208 (e.g., instruments to measure visibility and/or fog density), soil condition sensors 209 (e.g., probes to assess soil conditions such as moisture, temperature, and conductivity), water quality sensors 213 to evaluate water quality parameters like pH, dissolved oxygen, conductivity, and turbidity; and/or other sensors 211, such as but not limited to, anemometers, barometers, hygrometers, thermometers, pyranometers, and ceilometers, chosen for their precision in measuring specific atmospheric elements like wind speed, pressure, humidity, temperature, solar radiation, and cloud height. Alternatively, the system might integrate data from remote sensing technologies, which can cover broader areas and provide comprehensive atmospheric data.

These sensors may be deployed individually or integrated into comprehensive systems such as weather stations, environmental monitoring networks, or automated weather observing systems (AWOS) for real-time data collection and analysis. In some cases, the system 210 incorporates advanced data logging and transmission capabilities to relay collected data to a processing unit 212 or data store 214 for detailed analysis and/or forecasting. The data store 214 may be an embodiment of the data store 112 of FIG. 1.

The data store 214 can store environmental data collected from the various sensors and/or measurement devices. The data store 214 can maintain historical, real-time, current, and/or forecasted environmental data. The information of the data store 214 can be accessible by other components of environment 100 via the network 102.

In some cases, the environmental monitoring and/or forecasting system 210 can include or be implemented as a sophisticated meteorological data system or a network of such systems, equipped with localized and remote sensing technologies including, but not limited to, radar, lidar, and satellites. These technologies can enable the gathering of atmospheric data over extensive areas, enhancing the system's forecasting capabilities.

In some cases, the environmental monitoring and/or forecasting system 210 can access or store forecast data from various meteorological models or databases that integrate real-time, near-real-time, and/or historically modeled data. In some cases, the environmental monitoring and/or forecasting system 210 can include or communication with meteorological platforms such as, but not limited to, the National Centers for Environmental Prediction (NCEP) Operational Model Archive and Distribution System (NOMADS), the Global Forecast System (GFS), the North American Model (NAM), or the High-Resolution Rapid Refresh (HRRR) model. These models are frequently updated and can include current environmental data reflecting immediate weather conditions from multiple observation tools, including weather stations, aircraft, radar, and satellites such as GOES, MODIS, and Sentinel 2A, which provide detailed imagery on cloud cover, radiance, and other critical atmospheric parameters.

The data store 214 can include or be implemented as cloud storage, such as Amazon Simple Storage Service (S3), Elastic Block Storage (EBS) or CloudWatch, Google Cloud Storage, Microsoft Azure Storage, InfluxDB, etc. The data store 214 can be made up of one or more data stores storing data that has been received from one or more of the environmental monitoring and/or forecasting system 210, the heat stress monitoring system 120, the heat stress forecasting system 130, the client device 140, and/or the client application 142. The data store 214 can be configured to provide high availability, highly resilient, low loss data storage. The data store 214 can include Amazon CloudWatch metrics. In some cases, to provide the high availability, highly resilient, low loss data storage, the data store 214 can store multiple copies of the data in the same and different geographic locations and across different types of data stores (e.g., solid state, hard drive, tape, etc.). Further, as data is received at the data store 214 it can be automatically replicated multiple times according to a replication factor to different data stores across the same and/or different geographic locations.

This data can include, but is not limited to, real-time, near-real-time, or historically modeled information, which may be gathered from manual observations, weather stations, satellites, radar, aircraft, ocean buoys, or other observation tools. In this way, the data of the environmental monitoring and forecasting system 210 can provide a detailed view of weather patterns, climate trends, atmospheric conditions, or the like.

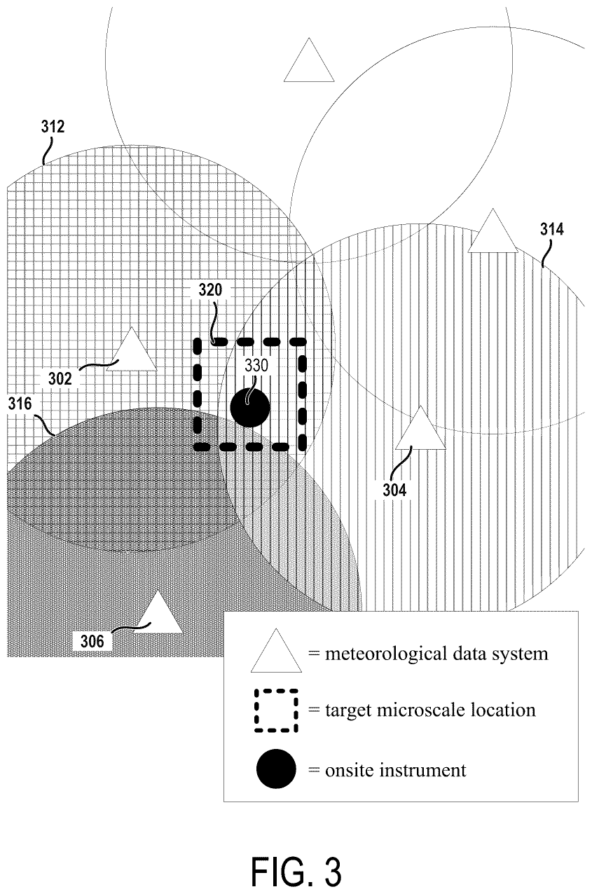

FIG. 3 illustrates a geographic representation of various meteorological data systems in relation to a target microscale location 320, exemplifying the application of some of the disclosed inventive concepts. In FIG. 3, meteorological data systems 302, 304, and 306 are represented by triangles, each associated with a geographic area 312, 314, and 316, respectively. These geographic areas represent the regions from which each meteorological data system collects data.

Each meteorological data system can collect information from multiple sensors distributed throughout its geographic area. For instance, meteorological data system 302 can collect data from sensors scattered across geographic area 312. The data collected by these sensors may then be amalgamated to provide an overall representation of environmental conditions, such as temperature, humidity, wind characteristics, and atmospheric cloud cover, for the entire area 312.

However, often, this amalgamated data represents average conditions over the broader geographic area and may not accurately reflect the specific environmental conditions at the target microscale location 320. The target microscale location 320, indicated by the square, dotted outline, intersects or touches the geographic areas 312, 314, 316 corresponding to meteorological data systems 302, 304, and 306. This intersection highlights the challenge of obtaining precise, localized environmental data tailored to the specific needs of microscale locations using standard meteorological data systems.

In a scenario where the heat stress forecasting system 130 aims to obtain a forecast of an environmental heat stress index specific to the target microscale location 320, the process can include acquiring forecast data from one or more of the meteorological data systems 302, 304, and 306, which at least partially surround the target microscale location. In some cases, the heat stress forecasting system 130 may select the nearest weather monitoring system, such as meteorological data system 302, to the target microscale location 320 and use information from this system exclusively. The forecast data can include parameters such as relative humidity, air temperature, wind characteristics, atmospheric cloud cover, and general terrain data.

Additionally, the heat stress forecasting system 130 can obtain localized terrain data for the target microscale location 320. The localized data can be sourced from at least one of the following: a Geographic Information System (GIS) that integrates layers of data representing urban structures, terrain features, or vegetation; satellite imagery or aerial photography providing information on land cover or urban development; topographic maps or surveys conducted by national or regional mapping agencies detailing contours, elevations, or specific landscape features; environmental sensors deployed in the designated location (e.g., onsite instrument 330) gathering real-time or periodic data on soil conditions, vegetation health, or urban heat islands; or local observations.

The heat stress forecasting system 130 can perform a bias correction on the forecast data based on the localized terrain data. This step can align or correct the broad meteorological data of the meteorological data systems with the specific microclimatic characteristics of the target microscale location 330, thereby generating microscale forecast data. This refined forecast data can provide a more accurate and reliable prediction of the environmental heat stress index, tailored specifically to the unique conditions of the target microscale location 320.

### Forecasting Environmental Heat Stress for a Target Microscale Location

Forecast data offers predictions for future climatic conditions, which can be important for planning and decision-making in various sectors. Some inventive concepts described herein improve microscale forecasting by integrating localized terrain information into broader weather forecast data. Through this integration, the inventive concepts refine general weather predictions to include specific local details such as vegetation cover, surface roughness, and built structures, resulting in bias-corrected data, sometimes referred to as microscale forecast data. By incorporating localized terrain information, the resultant data can be tailored to accurately reflect the unique climatic conditions of a target microscale location-often a smaller, defined area such as a sports field, construction site, or festival grounds. These techniques can at least partially correct inherent biases in general forecasts, which are typically representative of a larger geographic area that includes or is proximate the target microscale location, thereby producing predictions that are more precise and directly relevant to the target microscale location.

Some inventive concepts described herein utilize microscale forecast data to generate a tailored forecast for an environmental heat stress index at a specific microscale location. This forecasted index, which can include metrics such as the Wet Bulb Globe Temperature (WBGT), can reflect factors like temperature, humidity, wind speed, sun angle, or cloud cover to assess potential heat-related risks. This forecast value can represent a predicted heat-related risk that individuals might experience at a future time at the target microscale location. Such a forecasting can advantageously facilitate precise predictions of heat-related risks and supports the implementation of targeted preventive measures, enhancing safety and health management at these finely specified locations.

As an example, forecasting the environmental heat stress index for multiple soccer fields can allow sports event organizers to compare predicted conditions for various locations (e.g., potential soccer fields) and times. By receiving forecasted indices for hours, days, or even weeks ahead, organizers can select the field that offers the most favorable conditions for the desired game time. Alternatively, if a specific field is preferred, organizers can use the forecast to determine the best day or time that aligns with an acceptable heat stress index, ensuring athlete safety and comfort. This forecasting capability, which can project the heat stress index a few hours to several weeks or further in advance, can empower decision-makers to strategically plan events by choosing favorable times and locations that reduce heat-related risks in vulnerable microscale environments.

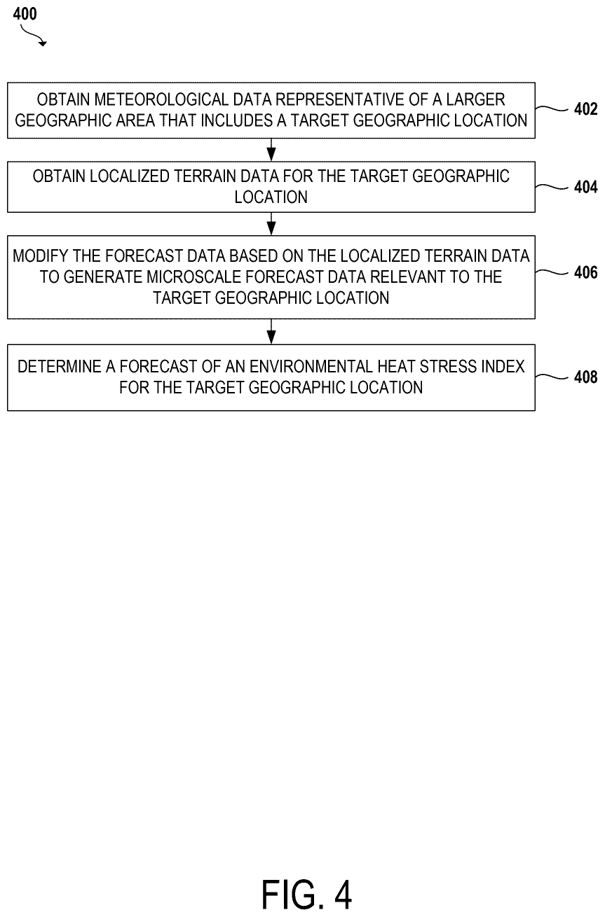

FIG. 4 is a flow diagram illustrative of an embodiment of a routine 400 for generating a forecast of environmental heat stress for a target microscale location. Although described as being implemented by the heat stress forecasting system 130, it will be understood that one or more elements outlined for routine 400 can be implemented by one or more computing devices/components that are associated with the environment 100, such as, but not limited to, the environmental monitoring and/or forecasting system 110, the heat stress monitoring system 120, the client device 140, and/or the client application 142. Thus, the following illustrative embodiment should not be construed as limiting.

At block 402, the heat stress forecasting system 130 can obtain meteorological data. Meteorological data can include, but is not limited to, historical records, current observations, and/or forecast predictions. Historical records can refer to past environmental conditions collected over a period of time and may include trends or patterns. Current observations can include recent environmental data, capturing conditions shortly before analysis but not necessarily in real time. Forecast predictions can include projections of future weather or environmental conditions, for example based on modeling, historical trends, and/or current data. In some cases, the meteorological data may not be specific to the target microscale location; instead, it can represent a larger geographic area that includes or is proximate to the target microscale location. This broader data may reflect averages or aggregated information from various points within the larger area. For example, the larger geographic area can be a town, while the target microscale location can be a sports field within that town. The meteorological data might then represent overall weather patterns and conditions of the town but may not accurately reflect the specific conditions of the sports field.

The meteorological data can include parameters relating to relative humidity, air temperature, wind characteristics, atmospheric cloud cover, or terrain data. Parameters relating to relative humidity can include, but are not limited to, absolute humidity (e.g., grams of water vapor per cubic meter of air), specific humidity (e.g., grams of water vapor per kilogram of air), vapor pressure (e.g., millibars), or dew point measurements (e.g., the temperature at which air becomes saturated with moisture). Parameters relating to air temperature can include, but are not limited to, current temperature, daily maximum or minimum temperatures (e.g., highest and lowest temperature recorded during a 24-hour period), heat index (e.g., a measure that combines air temperature and relative humidity to determine the apparent temperature), or temperature fluctuations over specific periods (e.g., hourly or daily temperature changes). Parameters relating to wind characteristics can include, but are not limited to, wind speed at various altitudes (e.g., measured in meters per second), wind direction (e.g., reported in degrees from true north), wind gust frequency (e.g., number of gusts per hour), or turbulence intensity (e.g., variations in wind speed and direction). Parameters relating to atmospheric cloud cover can include, but are not limited to, cloud coverage percentage (e.g., percentage of the sky covered by clouds), cloud base height (e.g., altitude of the lowest part of the clouds), cloud type (e.g., cirrus, cumulus), or cloud density (e.g., optical thickness). Parameters relating to terrain data can include, but are not limited to, land elevation (e.g., meters above sea level), land cover type (e.g., forest, urban, water bodies), surface roughness (e.g., texture and irregularities of the earth's surface), surface albedo (e.g., the reflectivity of the earth's surface), surface types such as asphalt or grass (e.g., urban developments, water bodies, vegetation, etc.), or radiant temperature (e.g., mean radiant temperature).

The source(s) of the meteorological data can vary across embodiments. For example, in some cases, a source of the meteorological data can include one or more localized sensors, such as, but not limited to, anemometers, barometers, hygrometers, thermometers, pyranometers, and ceilometers. These sensors can be specifically chosen based on their ability to accurately measure various atmospheric elements including, but not limited to, wind speed, atmospheric pressure, humidity, temperature, solar radiation, or cloud height. As another example, in some cases, a source of the meteorological data can include one or more remote sensing technologies such as, but not limited to, radar, lidar, satellites, or drones, which can gather atmospheric data over comparatively broader areas.

In some cases, the heat stress forecasting system 130 can obtain meteorological data from various models or databases that include forecast data, or real-time, near-real-time, or historically modeled data. For example, the meteorological data can be obtained from one or more meteorological platforms such as, but not limited to, the National Centers for Environmental Prediction (NCEP) Operational Model Archive and Distribution System (NOMADS), or models such as, but not limited to, the Global Forecast System (GFS) or the North American Model (NAM). Other sources may include the National Digital Meteorological database (NDFD), the National Blend of Models (NBM), or the High-Resolution Rapid Refresh (HRRR) model, which typically update forecasts every 15 minutes. In some cases, the meteorological data can include current environmental data that reflects immediate weather conditions. The current environmental data (sometimes referred to as real-time data) can be sourced from the NCEP Meteorological Assimilation Data Ingest System (MADIS), the Rapid Update Cycle (RUC) Surface Assimilation System (RSAS), or various observation tools including, but not limited to, weather stations, aircraft, radar, or satellites like GOES, MODIS, and Sentinel 2A, which can provide detailed imagery on cloud cover, radiance, or other atmospheric parameters such as lightning activity.

The meteorological data can reflect periodic updates, refreshed at intervals such as every X number of minutes, where X can be 5, 15, 60, 120 or any other specified duration. In some cases, the meteorological data can include older data, such as observations collected several hours or days previously. In some cases, the meteorological data include future weather forecasts, such as predictions for conditions hours, days, or even weeks in advance. This forward-looking data enables proactive planning for potential heat-related risks.

The meteorological data utilized can be sourced from one or more sensors of the same or different types positioned at the same or different altitudes. For example, sensors located at higher altitudes can measure upper atmospheric conditions, such as jet stream patterns or cloud formations, while those positioned closer to the ground can provide detailed readings on surface temperature, humidity, or local wind speeds.

In some cases, there may be multiple sources of the meteorological data. In some such cases, the different sources may correspond to the same or different geographic areas, which can vary in size and proximity to the target microscale location. For instance, some of the data might be drawn from regions that extend beyond the boundaries of the target microscale location, providing a broader context for the local conditions. In other cases, data sources may be proximate to the target microscale location, offering highly localized information that is more directly relevant to the specific area of interest. This variation in geographic coverage allows the heat stress forecasting system 130 to balance broad-scale meteorological trends with localized conditions, ensuring that the forecasts are both comprehensive and specific to the needs of the target microscale location.

At block 404, the heat stress forecasting system 130 obtains localized terrain data for the target microscale location. The localized terrain data can convey information about the physical attributes of the target microscale location, which can influence local atmospheric conditions. By integrating the localized terrain data in an analysis, the heat stress forecasting system 130 can more accurately model and predict environmental conditions specific to the target microscale location.

The localized terrain data can include one or more parameters related to physical attributes that influence local atmospheric conditions. These parameters can include, but are not limited to, albedo (reflectivity of surfaces), surface roughness, elevation, vegetation cover, soil moisture, and land-use patterns.

Albedo can quantify the reflectivity of terrestrial surfaces, affecting how much solar energy is absorbed or reflected by the ground. Surface roughness can measure the texture of the ground surface, which influences wind flow and turbulence. Elevation data can provide information on the height of the terrain, affecting temperature and precipitation patterns. Vegetation cover, including the density and health of plant life, can impact local humidity and temperature. Soil moisture data can convey the water content in the soil, influencing evaporation rates and local humidity. Land-use patterns can describe the distribution of different land types, such as urban areas, forests, impervious surfaces, asphalt, or water bodies, which can affect local climate conditions.

The localized terrain data can be sourced from various technologies and methods. For example, in some cases, satellite imagery can provide detailed visual and spectral information about the land surface, useful for calculating parameters such as albedo, NDVI (Normalized Difference Vegetation Index), and surface roughness. In some cases, remote sensing technologies, including LIDAR and aerial photography, can capture high-resolution elevation data and detailed land-cover information. Ground-based sensors can provide real-time soil moisture readings and other relevant data. Geographic Information Systems (GIS) can integrate multiple data sources to create terrain models. By obtaining and integrating these diverse data sources, the heat stress forecasting system 130 can generate detailed localized terrain data that accurately reflects the microclimatic variations of the target microscale location.

At block 406, the heat stress forecasting system 130 generates microscale environmental data based on the meteorological data and the localized terrain data. As described herein, microscale meteorological data can refer to location-specific environmental data that reflects unique physical attributes and microclimatic variations of the target microscale location, such as factors such as wind speed, boundary layer mixing, or humidity relevant to the target microscale location.

In some cases, to generate the microscale environmental data, the heat stress forecasting system 130 can perform a bias correction or tuning on the meteorological data. In some such cases, the heat stress forecasting system 130 can refine or adjust the meteorological data, resulting in microscale environmental data that more accurately represents the specific conditions at the target microscale location. This refined data may be considered an enhanced version of the meteorological data, adjusted to account for localized terrain of the target microscale location. In addition or alternatively, the microscale environmental data can be generated as an entirely new data set, disparate from the meteorological data. This separate data set can be derived by integrating the meteorological data with localized terrain data. By combining these diverse sources of information, the heat stress forecasting system 130 can produce a representation of the environmental conditions at the target microscale location.

As described herein, the meteorological data may reflect a broader geographic area, such as a region or town, but may not accurately reflect the specific conditions at the target microscale location, such as a sports field or construction site within that area. In some cases, bias-correcting the meteorological data can increase a likelihood that the values more accurately represent the conditions at the target microscale location.

In some cases, generating the microscale meteorological data can include determining a solar radiation parameter for the target microscale location based on the meteorological data, such as real-time cloud coverage data from multiple atmospheric levels. For example, the heat stress forecasting system 130 can integrate cloud cover information at different heights to estimate the amount of solar radiation reaching the surface at the target location. This integration can involve calculating the total solar radiation by considering the reduction in solar energy due to cloud cover at various atmospheric levels.

In some cases, generating the microscale meteorological data can include determining a wind parameter for a first altitude based on historical wind characteristics data measured at a second, higher altitude and adjusted using the historical localized terrain data. This adjustment can account for the impact of local physical attributes on wind speed and direction, providing a more accurate representation of wind conditions at the target microscale location. For example, generating the wind parameter can involve using historical data to understand wind patterns at a higher altitude and applying localized terrain data to predict how these patterns will change closer to the ground.

By making adjustments and corrections, the heat stress forecasting system 130 can generate microscale meteorological data that reflects the target microscale location. This data can provide a reliable basis for assessing and predicting heat stress conditions at the target microscale location, enhancing the precision and effectiveness of environmental condition models.

At block 408, the heat stress forecasting system 130 can calculate a value for an environmental heat stress index specific to the target microscale location based on the microscale meteorological data. In some cases, the forecast value may represent a predicted heat-related risk over a future time period at the target geographic location. This forecast value can provide a prediction of heat stress conditions, tailored to the unique environmental factors present at the target location.

In some cases, the environmental heat stress index is at least one of the Wet Bulb Globe Temperature (WBGT) or the Universal Thermal Climate Index (UTCI), which can assess heat stress levels based on multiple climatic variables. In some such cases, to calculate this forecast, the heat stress forecasting system 130 can integrate various environmental parameters, such as temperature, humidity, wind speed, solar radiation, and cloud cover, derived from the microscale meteorological data. In some cases, the WBGT can be calculated using Equation 1, above. In some cases, additional adjustments can be made to the formula to account for localized terrain data and specific environmental conditions at the microscale location. These adjustments can involve bias corrections based on factors such as surface roughness, vegetation cover, and elevation.

As a non-limiting example, consider a target microscale location such as a sports field. If the calculated WBGT value is 30° C., it may indicate a high level of heat stress, suggesting that activities may need to be modified to prevent heat-related illnesses. On the other hand, a WBGT value of 25° C. may indicate a moderate level of heat stress, where precautions like increased hydration and rest breaks may be advisable. In some cases, a WBGT value of 20° C. or below may indicate a lower risk of heat stress, allowing for normal activity levels with standard precautions.

Similarly, the UTCI can provide another perspective on heat stress conditions. A UTCI value of 32° C. or higher can indicate extreme heat stress, necessitating significant measures to protect individuals from heat-related health risks. A UTCI value between 26° C. and 32° C. can indicate strong heat stress, requiring caution and the implementation of heat mitigation strategies. Values between 18° C. and 26° C. can indicate moderate heat stress, where standard heat precautions should be taken. Values below 18° C. may indicate low heat stress, where usual activities can be conducted with minimal risk.

It will be understood that fewer, more, or different blocks can be used as part of the routine 400 of FIG. 4. For example, in some cases, the heat stress forecasting system 130 can obtain an indication of a future time period from a user input. The forecast value for the environmental heat stress index can then be calculated based on the indicated future time period. This scenario can arise when users, such as event planners or construction managers, need specific forecasts for upcoming activities. By incorporating user-provided inputs regarding the desired time period, the system can generate targeted heat stress predictions that align with the user's scheduling needs. This approach ensures that the forecasted data is highly relevant and useful for planning and decision-making, thereby enhancing safety and efficiency in managing heat-related risks. Conversely, if no specific time period is indicated by the user, the system can default to providing forecasts for standard intervals, ensuring continuous and comprehensive monitoring of environmental conditions.

As mentioned, the meteorological data may not be specific to the target geographic location but may be representative of a larger geographic area that includes the target geographic location. In some cases, as part of the routine 400, the heat stress forecasting system 130 can obtain second meteorological data specific to the target geographic location. The second meteorological data can include at least one of direct in situ observations, sensor data from handheld or onsite instruments, or imagery depicting current meteorological or environmental conditions at the target geographic location. This data can provide more precise and immediate information, such as real-time cloud cover or sky view factor. For instance, a user may provide local observations through pictures taken from their phone, capturing real-time conditions such as cloud cover. These user-contributed data points can enhance the precision of the heat stress index calculation by offering localized and up-to-date environmental information. By integrating both the broader and localized data, the heat stress forecasting system 130 can refine its predictions and provide a more accurate assessment of heat stress conditions at the target microscale location. The calculation of the value for the environmental heat stress index can be further based on the second meteorological data, ensuring that the index accurately reflects the specific conditions at the target geographic location.

### Real-Time Environmental Heat Stress for a Target Microscale Location

Real-time data provides immediate information on current climatic conditions, which is critical for ongoing activities and immediate decision-making in various sectors. Some inventive concepts described herein improve microscale assessment by integrating localized terrain information into broader real-time weather data. Through this integration, the inventive concepts refine general weather observations to include specific local details such as vegetation cover, surface roughness, and built structures, resulting in bias-corrected data, sometimes referred to as microscale real-time data. By incorporating localized terrain information, the resultant data can be tailored to accurately reflect the unique climatic conditions of a target microscale location, often a smaller, defined area such as a sports field, construction site, or festival grounds. These techniques can at least partially correct inherent biases in general observations, which are typically representative of a larger geographic area that includes or is proximate to the target microscale location, thereby producing observations that are more precise and directly relevant to the target microscale location.

Some inventive concepts described herein utilize microscale real-time data to generate a tailored value for an environmental heat stress index at a specific microscale location. This current value, which can include metrics such as the Wet Bulb Globe Temperature (WBGT), can reflect factors like temperature, humidity, wind speed, sun angle, or cloud cover to assess immediate heat-related risks. This real-time value represents the current heat-related risk that individuals might experience at the target microscale location. Such real-time assessment can advantageously facilitate immediate responses to heat-related risks and support the implementation of targeted preventive measures, enhancing safety and health management at these finely specified locations.

As an example, assessing the environmental heat stress index for a sports practice session in real-time can allow coaches to adjust practice plans to ensure athlete safety. By receiving real-time indices, coaches can implement immediate changes such as increasing the frequency of water breaks, modifying the intensity of drills, or relocating practice to a shaded area. This capability is particularly useful for sports practices, where conditions can change rapidly and adjustments can be made without significant disruption. Real-time data enables coaches to monitor conditions continuously and make informed decisions to protect the health and safety of athletes. This real-time assessment capability, providing current heat stress indices, empowers coaches to respond swiftly to changing conditions, ensuring safety, and reducing heat-related risks in vulnerable microscale environments.

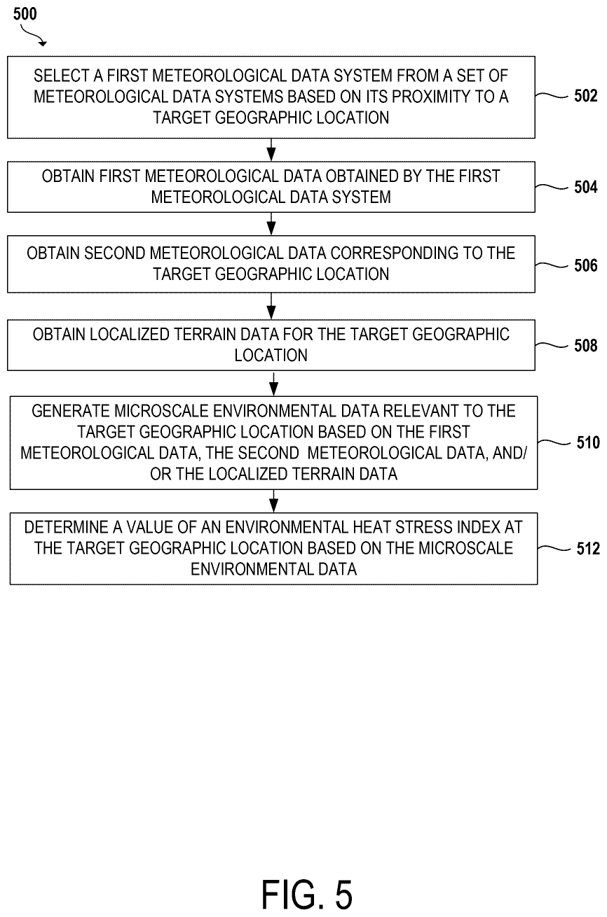

FIG. 5 is a flow diagram illustrative of an embodiment of a routine 500 for determining current values of environmental heat stress for a target microscale location. Although described as being implemented by the heat stress monitoring system 120, it will be understood that one or more elements outlined for routine 500 can be implemented by one or more computing devices/components that are associated with the environment 100, such as, but not limited to, the environmental monitoring and/or forecasting system 110, the heat stress forecasting system 130, the client device 140, and/or the client application 142. Thus, the following illustrative embodiment should not be construed as limiting.

At block 502, the heat stress monitoring system 120 selects a first meteorological data system from a set of meteorological data systems. In some cases, the selection can be based on criteria such as proximity to the target geographic location. The criteria can include, but are not limited to, selecting the nearest weather monitoring system, selecting a system that provides the highest resolution data, selecting based on the reliability of the data source, or selecting a system that has the most comprehensive historical data. For example, if the target geographic location is a sports field within a city, the system can select the weather monitoring station located at the nearest airport or university weather station. Alternatively, the system might select a weather station known for providing high-resolution data or one that has consistently reliable measurements. This selection can ensure that the most relevant and accurate meteorological data is obtained for the specific area of interest, thereby improving the reliability of the heat stress assessment. The meteorological data can then be obtained by the selected first weather monitoring system, ensuring that it is representative of the conditions at the target geographic location.

At block 504, similar to block 402 of FIG. 4, the heat stress monitoring system 120 can obtain first meteorological data. The first meteorological data can be obtained from the first meteorological data system, or may be data that was collected by the first meteorological data system.

At block 506, the heat stress monitoring system 120 can obtain second meteorological data corresponding to the target geographic location. The second meteorological data can include localized and/or immediate observations, such as, but not limited to, direct in situ measurements, sensor data from handheld or onsite instruments, or imagery depicting current meteorological or environmental conditions at the target geographic location. The second meteorological data can provide precise and/or real-time information, including, but not limited to, real-time cloud cover or sky view factor. For instance, a user may provide local observations through pictures taken from their phone, capturing real-time conditions such as cloud cover. By obtaining this second meteorological data, the heat stress monitoring system 120 can access detailed and up-to-date environmental information specific to the target geographic location, enhancing the accuracy of the environmental heat stress assessment.

At block 508, similar to block 404 of FIG. 4, the heat stress monitoring system 120 can obtain localized terrain data for the target geographic location. This localized terrain data can include various physical attributes that influence local atmospheric conditions, such as albedo, surface roughness, elevation, vegetation cover, soil moisture, and land-use patterns.

At block 510, similar to block 406 of FIG. 4, the heat stress monitoring system 120 can generate microscale environmental data relevant to the target geographic location based on the first meteorological data and the localized terrain data. Furthermore, in some cases, the heat stress monitoring system 120 can generate microscale environmental data based on the second meteorological data. For example, similar to how the localized terrain data may be integrated or used with the first meteorological data to bias-correct the first meteorological data, the second meteorological data may also or alternatively be used to bias-correct the first meteorological data and/or the localized terrain data.

At block 512, similar to block 408 of FIG. 4, the heat stress monitoring system 120 can determine a value of an environmental heat stress index at the target geographic location based on the microscale environmental data. In this example, the value can be a measure of the current heat-related risk specific to the target location, enabling immediate and informed decision-making regarding activities and safety measures.

It will be understood that fewer, more, or different blocks can be used as part of the routine 500 of FIG. 5. For example, in some cases, the heat stress monitoring system 120 can incorporate additional data sources or techniques to enhance real-time heat stress assessment. This may include integrating user-provided data such as real-time images, obtaining second meteorological data specific to the target geographic location for more precise measurements, or using advanced algorithms for bias correction and data refinement. These modifications can ensure that the routine 500 is adaptable and can provide accurate, real-time environmental heat stress assessments tailored to the specific conditions of the target microscale location.

### Generating Localized Terrain Data for Environmental Condition Modeling

Accurate modeling and real-time assessment of environmental conditions at a target microscale location rely on detailed localized terrain data. Some inventive concepts described herein enhance the preprocessing of environmental data by integrating diverse sources such as satellite imagery and remote sensing technologies. These inventive concepts refine general environmental data to include specific local details such as vegetation cover, surface roughness, and elevation, resulting in comprehensive localized terrain data. By incorporating this localized terrain information, the resultant data can be tailored to accurately reflect the unique climatic conditions of the target microscale location.

The inventive concepts utilize localized terrain data to support the modeling and real-time assessment of environmental conditions. This data encompasses key parameters such as albedo, NDVI (Normalized Difference Vegetation Index), soil moisture, surface roughness, and elevation. These parameters capture the microclimatic variations unique to the target microscale location, enabling precise environmental modeling and improving the reliability of real-time assessments and climatic condition predictions.

For example, some inventive concepts described herein involve acquiring satellite-derived imagery to capture land-use and land-cover data for the target microscale location. This imagery is used to determine the albedo, which quantifies the reflectivity of terrestrial surfaces, and the NDVI, which characterizes the density and health of vegetation. Additionally, remote sensing technologies are utilized to obtain soil moisture data, assessing the hydrological conditions that influence local vegetation and microclimate stability. Surface roughness parameters, assessed in multiple cardinal directions based on the satellite-derived imagery and NDVI, help model the physical attributes impacting local atmospheric dynamics. Elevation data obtained from digital elevation models further refines the assessment of microclimatic conditions.

By integrating these diverse data sources—albedo, NDVI, soil moisture, surface roughness, and elevation—the inventive concepts generate localized terrain data that accurately reflects the microclimatic variations of the target microscale location. This comprehensive dataset supports real-time assessment and enhances the accuracy of climatic condition predictions, providing critical insights for various applications such as urban planning, agriculture, and disaster management.

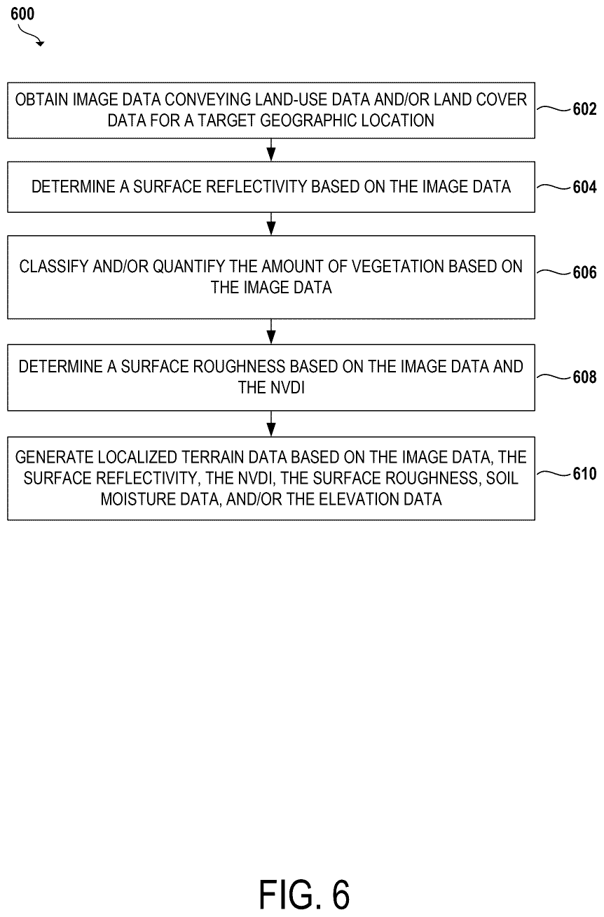

FIG. 6 is a flow diagram illustrative of an embodiment of a routine 600 for generating localized terrain data for environmental condition modeling. Although described as being implemented by the heat stress monitoring system 120, it will be understood that one or more elements outlined for routine 600 can be implemented by one or more computing devices/components that are associated with the environment 100, such as, but not limited to, the environmental monitoring and/or forecasting system 110, the heat stress forecasting system 130, the client device 140, and/or the client application 142. Thus, the following illustrative embodiment should not be construed as limiting.

At block 602, the system can obtain image data conveying land-use data and/or land cover data for a target geographic location. This image data can be sourced from, but not limited to, satellite imagery, aerial photography, local photographs from users, or other remote sensing technologies, providing detailed visual and spectral information about the land surface.

At block 604, the system can determine a surface reflectivity based on the image data. Surface reflectivity, or albedo, quantifies how much solar energy is reflected by the terrestrial surfaces, influencing microclimatic conditions as it relates to the radiative influences of the environment.

At block 606, the system can classify and quantify the amount of vegetation, such as the Normalized Difference Vegetation Index (NDVI) based on the image data. This provides insights into local vegetation cover and its impact on microclimate.

At block 608, the system can determine a surface roughness based on the image data and the NDVI. Surface roughness measures the texture and irregularities of the ground surface, affecting wind flow and turbulence in the area.

At block 610, the system can generate localized terrain data based on the image data, the surface reflectivity, the NDVI, the surface roughness, soil moisture data, built structure data, and/or the elevation data. This comprehensive terrain data accurately reflects the microclimatic variations of the target geographic location, supporting precise environmental modeling and real-time assessment of climatic conditions.

### Example Embodiments

Some embodiments of the present disclosure can be described in view of the following clauses:

Clause 1. A method for estimating a value for an environmental heat stress index at a target microscale location, the method comprising:
obtaining meteorological data, the meteorological data comprising parameters indicative of at least three of relative humidity, air temperature, wind characteristics, atmospheric cloud cover, radiant temperature, or general terrain data, wherein the meteorological data corresponds to a geographic area that is larger than and at least partially includes the target microscale location;
obtaining localized terrain data for the target microscale location, wherein the localized terrain data comprises one or more parameters relating to physical attributes that influence local atmospheric conditions;
performing a bias correction on the meteorological data to generate microscale meteorological data, wherein the bias correction is based on the localized terrain data, and adjusts for at least one of wind speed, boundary layer mixing, or humidity relevant to the target microscale location; and
calculating a value for an environmental heat stress index for the target microscale location based on the microscale meteorological data, wherein the value for the environmental heat stress index is a quantified measure of heat-related risk specific to the target microscale location, used for providing actionable insights or alerts to users for health and safety purposes.

Clause 2. The method of any of the preceding clauses, wherein the value for the environmental heat stress index is a real-time or near-real-time value for the environmental heat stress index at the target microscale location, wherein the current value represents an immediate heat-related risk specific to the target microscale location.

Clause 3. The method of any of the preceding clauses, wherein the value for the environmental heat stress index is a forecast value for the environmental heat stress index at the target microscale location, wherein the forecast value represents a predicted heat-related risk over a future time period at the target microscale location.

Clause 4. The method of clause 3, further comprising obtaining an indication of the future time period from a user input, wherein the forecast value is calculated based on the indicated future time period.

Clause 5. The method of any of the preceding clauses, further comprising selecting a first weather monitoring system from a set of weather monitoring systems based on a proximity of the first weather monitoring system to the target microscale location, wherein the meteorological data was obtained by the first weather monitoring system.

Clause 6. The method of clause 5, wherein selecting the first weather monitoring system from the set of weather monitoring systems comprises selecting a nearest weather monitoring system of a set of weather monitoring systems to target microscale location.

Clause 7. The method of any of the preceding clauses, wherein the meteorological data is first meteorological data that is not specific to the target microscale location but is representative of a larger geographic area that includes the target microscale location, and wherein the method further comprises obtaining second meteorological data specific to the target microscale location.

Clause 8. The method of clause 7, wherein the second meteorological data includes at least one of direct in situ observations, sensor data from handheld or onsite instruments, or imagery depicting current meteorological or environmental conditions at the target microscale location.

Clause 9. The method of clause 7, wherein the second meteorological data comprises information relating to cloud cover or sky view factor.

Clause 10. The method of any of the preceding clauses, wherein acquiring localized terrain data comprises obtaining data from at least one of the following:
a Geographic Information System (GIS) that integrates layers of data representing urban structures, terrain features, or vegetation;
satellite imagery or aerial photography that provide information on land cover or urban development;
topographic maps or surveys conducted by national or regional mapping agencies that detail contours, elevations, or specific landscape features;
environmental sensors deployed in the target microscale location that gather real-time or periodic data on soil conditions, vegetation health, or urban heat islands; or local observations.

Clause 11. The method of any of the preceding clauses, wherein the environmental heat stress index is Wet Bulb Globe Temperature (WBGT).

Clause 12. The method of any of the preceding clauses, wherein performing the bias correction comprises adjusting the meteorological data to account for differences in wind dynamics, atmospheric stratification, moisture content, and surface typologies between the geographic area and the target microscale location, to allow the microscale meteorological data to accurately reflects conditions at the target microscale location.

Clause 13. The method of any of the preceding clauses, wherein performing the bias correction comprises correcting biases in the meteorological data related to wind dynamics, atmospheric stratification, moisture content, or surface typologies that do not accurately reflect conditions at the target microscale location.

Clause 14. The method of any of the preceding clauses, wherein performing the bias correction comprises determining a solar radiation parameter for the target microscale location based on cloud coverage data from multiple atmospheric levels, wherein calculating the value for the environmental heat stress index for the target microscale location is based on the solar radiation parameter.

Clause 15. The method of any of the preceding clauses, wherein the meteorological data comprises historical wind characteristics at a first altitude, and wherein performing the bias correction comprises determining a wind parameter for the target microscale location that accounts for an impact of local physical attributes on wind speed and/or wind direction, based on the historical wind characteristics at the first altitude and the localized terrain data, wherein the wind parameter corresponds to a second altitude that is lower than the first altitude, and wherein calculating the value for the environmental heat stress index for the target microscale location is based on the wind parameter.

Clause 16. The method of clause 14, wherein the local physical attributes correspond to at least one of surface roughness, vegetation, buildings, or water bodies at the target microscale location.

Clause 17. The method of any of the preceding clauses, further comprising presenting the value for the environmental heat stress index within a user interface, configured to notify users of deviations in the environmental heat stress index relative to established thresholds over a defined monitoring period.

Clause 18. The method of any of the preceding clauses, further comprising:
collecting user-contributed data regarding actual environmental conditions at the target microscale location;
wherein the bias correction is further based on the user-contributed data.

Clause 19. A system for estimating a value for an environmental heat stress index at a target microscale location, the system comprising:
a processor configured to:
obtain meteorological data, the meteorological data comprising parameters indicative of at least three of relative humidity, air temperature, wind characteristics, atmospheric cloud cover, or general terrain data, wherein the meteorological data corresponds to a geographic area that is larger than and at least partially includes the target microscale location;
obtain localized terrain data for the target microscale location, wherein the localized terrain data comprises one or more parameters relating to physical attributes that influence local atmospheric conditions;
perform a bias correction on the meteorological data to generate microscale meteorological data, wherein the bias correction is based on the localized terrain data, and adjusts for at least one of wind speed, boundary layer mixing, radiative influences, or humidity relevant to the target microscale location; and
calculate a value for an environmental heat stress index for the target microscale location based on the microscale meteorological data, wherein the value for the environmental heat stress index is a quantified measure of heat-related risk specific to the target microscale location, used for providing actionable insights or alerts to users for health and safety purposes.

Clause 20. A non-transitory computer-readable media comprising computer-executable instructions that, when executed by one or more processors, cause the one or more processors to perform a method for estimating a value for an environmental heat stress index at a obtaining meteorological data, the meteorological data comprising parameters indicative of at least three of relative humidity, air temperature, wind characteristics, atmospheric cloud cover, or general terrain data, wherein the meteorological data corresponds to a geographic area that is larger than and at least partially includes the target microscale location;

obtaining localized terrain data for the target microscale location, wherein the localized terrain data comprises one or more parameters relating to physical attributes that influence local atmospheric conditions;

performing a bias correction on the meteorological data to generate microscale meteorological data, wherein the bias correction is based on the localized terrain data, and adjusts for at least one of wind speed, boundary layer mixing, radiative influences, or humidity relevant to the target microscale location; and calculating a value for an environmental heat stress index for the target microscale location based on the microscale meteorological data, wherein the value for the environmental heat stress index is a quantified measure of heat-related risk specific to the target microscale location, used for providing actionable insights or alerts to users for health and safety purposes.

Some embodiments of the present disclosure can be described in view of the following clauses:

Clause 1. A method for generating a forecast of environmental heat stress for a target microscale location, using a forecasting model, comprising:
obtaining an indication of a future time period;
obtaining forecast data corresponding to multiple sensors located at varying altitudes, wherein the forecast data comprises parameters relating to relative humidity, air temperature, wind characteristics, atmospheric cloud cover, or general terrain data, and wherein the forecast data corresponds to at least one geographic area, wherein each geographic area of the at least one geographic area includes and at least partially surrounds a target microscale location;
obtaining localized terrain data for the target microscale location, wherein the localized terrain data comprises one or more parameters relating to physical attributes that influence local atmospheric conditions;
determining a solar radiation parameter for the target microscale location based on real time cloud coverage data from multiple atmospheric levels;
determining a wind parameter at a lower, first altitude by using historical wind characteristics data measured at a higher, second altitude and adjusting the historical wind characteristics data based on the localized terrain data, wherein the adjusting at least partially accounts for an impact of local physical attributes on wind speed and direction; and
calculating a forecast value for an environmental heat stress index specific to target microscale location based on the solar radiation parameter, the wind parameter, and the forecast data, wherein the wherein the forecast value represents a predicted heat-related risk over the future time period at the target microscale location.

Clause 2. The method of any of the preceding clauses, wherein acquiring the forecast data comprising acquiring the forecast data from a meteorological data system.

Clause 3. The method of any of the preceding clauses, wherein the local physical attributes comprises data relating to at least one of surface roughness, vegetation, buildings, or water bodies.

Clause 4. The method of any of the preceding clauses, wherein the localized terrain data is obtained using geographic information system (GIS) technology.

Clause 5. The method of any of the preceding clauses, further comprising updating the forecast value for the target microscale location in real-time as new forecast data becomes available.

Clause 6. The method of any of the preceding clauses, wherein the environmental heat stress index variable is Wet Bulb Globe Temperature (WBGT).

Clause 7. The method of any of the preceding clauses, further comprising presenting the forecast value within a user interface, configured to notify users of deviations in the environmental heat stress index relative to established thresholds over a defined monitoring period.

Clause 8. The method of any of the preceding clauses, calculating the forecast value comprises adjusting the forecast data by aligning the forecast data with real-time local weather conditions sourced from a weather monitoring installation proximate to the target microscale location.

Clause 9. The method of any of the preceding clauses, calculating the forecast value comprises correcting biases related to wind dynamics, atmospheric stratification, moisture content, or surface typologies.

Clause 10. The method of any of the preceding clauses, calculating the forecast value comprises:
analyzing the forecast data to identify deviations from expected atmospheric models concerning wind patterns, temperature gradients, and humidity levels;
applying correction algorithms to adjust the forecast data based on identified deviations, wherein the algorithms are configured to at least one of:
modify wind speed estimates to reflect local surface features and obstacles, adjust temperature profiles to account for observed atmospheric stability or instability, and
recalibrate humidity measurements to correct sensor biases or environmental factors influencing moisture readings.

Clause 11. The method of clause 10, further comprising:
integrating the adjusted forecast data into a weather prediction model to refine an accuracy of impending weather conditions; and
iteratively updating the correction algorithms based on a feedback loop involving subsequent weather outcomes and additional sensor data to continually enhance forecast reliability.

Clause 12. The method of any of the preceding clauses, wherein determining the wind parameter comprises analyzing wind speed and direction data to identify inconsistencies or deviations from expected patterns due to local topography or surface roughness.

Clause 13. The method of any of the preceding clauses, further comprising:
collecting user-contributed data regarding actual environmental conditions at the target microscale location;
analyzing the user-contributed data to identify variances between a parameter in a forecasting model and the actual environmental conditions; and
adjusting the parameters of the forecasting model to address the variances.

Clause 14. The method of any of the preceding clauses, wherein determining the solar radiation parameter for the target microscale location is comprises:
analyzing the cloud coverage data from multiple atmospheric levels to predict solar radiation impact using a trained machine learning model that accounts for historical patterns and predictive analytics; and
determining the solar radiation parameter based on real-time cloud data and feedback to refine an accuracy of the solar radiation parameter.

Clause 15. The method of any of the preceding clauses, wherein determining the wind parameter includes employing a machine learning model that utilizes historical data to enhance predictions of wind conditions at lower altitudes based on observed wind conditions at higher altitudes.

Clause 16. A system for estimating a forecast value for an environmental heat stress index at a target microscale location, the system comprising:
a processor configured to:
obtain an indication of a future time period;
obtain forecast data corresponding to multiple sensors located at varying altitudes, wherein the forecast data comprises parameters relating to relative humidity, air temperature, wind characteristics, atmospheric cloud cover, or general terrain data, and wherein the forecast data corresponds to at least one geographic area, wherein each geographic area of the at least one geographic area includes and at least partially surrounds a target microscale location;
obtain localized terrain data for the target microscale location, wherein the localized terrain data comprises one or more parameters relating to physical attributes that influence local atmospheric conditions;
determine a solar radiation parameter for the target microscale location based on real time cloud coverage data from multiple atmospheric levels;
determine a wind parameter at a lower, first altitude by using historical wind characteristics data measured at a higher, second altitude and adjusting the historical wind characteristics data based on the localized terrain data, wherein the adjusting at least partially accounts for an impact of local physical attributes on wind speed and direction; and
calculate a forecast value for an environmental heat stress index specific to target microscale location based on the solar radiation parameter, the wind parameter, and the forecast data, wherein the wherein the forecast value represents a predicted heat-related risk over the future time period at the target microscale location.

Clause 17. A non-transitory computer-readable media comprising computer-executable instructions that, when executed by one or more processors, cause the one or more processors to perform a method for estimating a forecast value for an environmental heat stress index at a target microscale location, the method comprising:
obtaining an indication of a future time period;
obtaining forecast data corresponding to multiple sensors located at varying altitudes, wherein the forecast data comprises parameters relating to relative humidity, air temperature, wind characteristics, atmospheric cloud cover, or general terrain data, and wherein the forecast data corresponds to at least one geographic area, wherein each geographic area of the at least one geographic area includes and at least partially surrounds a target microscale location;
obtaining localized terrain data for the target microscale location, wherein the localized terrain data comprises one or more parameters relating to physical attributes that influence local atmospheric conditions;
determining a solar radiation parameter for the target microscale location based on real time cloud coverage data from multiple atmospheric levels;
determining a wind parameter at a lower, first altitude by using historical wind characteristics data measured at a higher, second altitude and adjusting the historical wind characteristics data based on the localized terrain data, wherein the adjusting at least partially accounts for an impact of local physical attributes on wind speed and direction; and
calculating a forecast value for an environmental heat stress index specific to target microscale location based on the solar radiation parameter, the wind parameter, and the forecast data, wherein the wherein the forecast value represents a predicted heat-related risk over the future time period at the target microscale location.

Some embodiments of the present disclosure can be described in view of the following clauses:

Clause 1. A method for real-time estimation of an environmental heat stress index at a target microscale location, the method comprising:
selecting a first meteorological data system from a set of meteorological data systems based on a proximity of the first meteorological data system to a target microscale location;
acquiring first environmental data obtained by the first meteorological data system, wherein the environmental data comprises parameters relating to relative humidity, air temperature, wind characteristics, and atmospheric cloud cover;
acquiring localized terrain data for the target microscale location, wherein the localized terrain data comprises one or more parameters relating to physical attributes that influence local atmospheric conditions;
performing a bias correction on the first environmental data to generate microscale environmental data, wherein the performing is based on the localized terrain data, wherein the bias correction adjusts for at least one of wind speed, boundary layer mixing, radiative influences, or humidity relevant to the target microscale location; and
calculating a value for the environmental heat stress index for the target microscale location based on the microscale environmental data.

Clause 2. The method of any of the preceding clauses, wherein the value for the environmental heat stress index is a real-time or near-real-time value for the environmental heat stress index at the target microscale location, wherein the value represents an immediate heat-related risk specific to the target microscale location.

Clause 3. The method of any of the preceding clauses, further comprising:
acquiring second environmental data corresponding to the target microscale location, wherein the second environmental data reflects at least one of direct in situ observations, sensor data from handheld or onsite instruments, or images depicting current meteorological or environmental conditions;
wherein the performing is based on the second environmental data and the localized terrain data.

Clause 4. The method of any of the preceding clauses, wherein selecting the first meteorological data system from the set of meteorological data systems comprises selecting a nearest weather monitoring system of a set of weather monitoring systems to target microscale location.

Clause 5. The method of any of the preceding clauses, wherein the second real-time environmental data comprises cloud cover or sky view factor.

Clause 6. The method of any of the preceding clauses, wherein acquiring localized terrain data comprises obtaining data from at least one of the following:
a Geographic Information System (GIS) that integrates layers of data representing urban structures, terrain features, or vegetation;
satellite imagery or aerial photography that provide information on land cover or urban development;
topographic maps or surveys conducted by national or regional mapping agencies that detail contours, elevations, or specific landscape features;
environmental sensors deployed in the target microscale location that gather real-time or periodic data on soil conditions, vegetation health, or urban heat islands; or local observations.

Clause 7. The method of any of the preceding clauses, wherein the environmental heat stress index is Wet Bulb Globe Temperature (WBGT).

Clause 8. A system for estimating a value for an environmental heat stress index at a target microscale location, the system comprising:
a processor configured to:
select a first meteorological data system from a set of meteorological data systems based on a proximity of the first meteorological data system to a target microscale location;
acquire first environmental data obtained by the first meteorological data system, wherein the environmental data comprises parameters relating to relative humidity, air temperature, wind characteristics, and atmospheric cloud cover;
acquire localized terrain data for the target microscale location, wherein the localized terrain data comprises one or more parameters relating to physical attributes that influence local atmospheric conditions;
perform a bias correction on the first environmental data to generate microscale environmental data, wherein the performing is based on the localized terrain data, wherein the bias correction adjusts for at least one of wind speed, boundary layer mixing, radiative influences, or humidity relevant to the target microscale location; and
calculate a value for the environmental heat stress index for the target microscale location based on the microscale environmental data.

Clause 9. A non-transitory computer-readable media comprising computer-executable instructions that, when executed by one or more processors, cause the one or more processors to perform a method for estimating a value for an environmental heat stress index at a
selecting a first meteorological data system from a set of meteorological data systems based on a proximity of the first meteorological data system to a target microscale location;
acquiring first environmental data obtained by the first meteorological data system, wherein the environmental data comprises parameters relating to relative humidity, air temperature, wind characteristics, and atmospheric cloud cover;
acquiring localized terrain data for the target microscale location, wherein the localized terrain data comprises one or more parameters relating to physical attributes that influence local atmospheric conditions;
performing a bias correction on the first environmental data to generate microscale environmental data, wherein the performing is based on the localized terrain data, wherein the bias correction adjusts for at least one of wind speed, boundary layer mixing, radiative influences, or humidity relevant to the target microscale location; and
calculating a value for the environmental heat stress index for the target microscale location based on the microscale environmental data.

Some embodiments of the present disclosure can be described in view of the following clauses:

Clause 1. A method for localized terrain data for a target microscale location, comprising:
obtaining satellite-derived imagery to capture land-use and/or land-cover data for a target microscale location;
determining an albedo of a surface of the earth based on the satellite-derived imagery, wherein the albedo quantifies a reflectivity of terrestrial surfaces;
calculating a normalized difference vegetation index (NDVI) based on the satellite-derived imagery, wherein the NDVI characterizes a density and/or a health of vegetation;
identifying changes in the NDVI over a predetermined historical period based on archived satellite imagery to derive time-specific and location-specific microclimatic parameters;
obtaining soil moisture data from remote sensing technologies to assess the hydrological conditions that influence local vegetation and microclimate stability;
determining surface roughness parameters in multiple cardinal directions based on the satellite-derived imagery and the NDVI;
obtaining elevation data from digital elevation models to further refine the assessment of microclimatic conditions; and
generating localized terrain data based on the albedo, the NDVI, the soil moisture data, the surface roughness parameters, and the elevation data, wherein the localized terrain data reflects the microclimatic conditions of the target microscale location.

Clause 2. The method of any of the preceding clauses, wherein the localized terrain data comprises data relating to at least one of surface roughness, vegetation, buildings, or water bodies.

Clause 3. The method of any of the preceding clauses, further comprising determining localized terrain characteristics based on the satellite-derived imagery, wherein the localized terrain characteristics include at least one of a reflectivity measurement of a terrestrial surface or a characterization of vegetative cover, wherein determining the surface roughness is further based on the localized terrain characteristics.

Clause 4. The method of clause 3, further comprising converting the localized terrain characteristics into a vector format compatible for environmental modeling.

Clause 5. The method of any of the preceding clauses, wherein the localized terrain data for the target microscale location comprises:
data on surface roughness parameters in multiple cardinal directions;
data on vegetation density and vegetation health;
data on reflectivity measurements of terrestrial surfaces, quantified as albedo;
data on soil moisture levels; and
data on elevation, representing topographical features.

Clause 6. The method of any of the preceding clauses, wherein the localized terrain data for the target microscale location includes:
vectorized data on surface roughness parameters in multiple cardinal directions;
data on temporal changes in vegetation density and health over a predetermined historical period;
data on albedo values representing the reflectivity of terrestrial surfaces;
data on soil moisture levels; and
data on elevation, detailing contours and heights of the terrain.

### Terminology

Any or all of the features and functions described above can be combined with each other, except to the extent it may be otherwise stated above or to the extent that any such embodiments may be incompatible by virtue of their function or structure, as will be apparent to persons of ordinary skill in the art. Unless contrary to physical possibility, it is envisioned that the methods/steps described herein may be performed in any sequence and/or in any combination, and the components of respective embodiments may be combined in any manner.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims, and other equivalent features and acts are intended to be within the scope of the claims.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Unless the context clearly requires otherwise, throughout the description and the claims, the words “comprise,” “comprising,” and the like are to be construed in an inclusive sense, as opposed to an exclusive or exhaustive sense, e.g., in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words using the singular or plural number may also include the plural or singular number, respectively. The word “or” in reference to a list of two or more items, covers all of the following interpretations of the word: any one of the items in the list, all of the items in the list, and any combination of the items in the list. Likewise, the term “and/or” in reference to a list of two or more items, covers all of the following interpretations of the word: any one of the items in the list, all of the items in the list, and any combination of the items in the list.

Conjunctive language such as the phrase “at least one of X, Y and Z,” unless specifically stated otherwise, is otherwise understood with the context as used in general to convey that an item, term, etc. may be either X, Y or Z, or any combination thereof. Thus, such conjunctive language is not generally intended to imply that certain embodiments require at least one of X, at least one of Y and at least one of Z to each be present. Further, use of the phrase “at least one of X, Y or Z” as used in general is to convey that an item, term, etc. may be either X, Y or Z, or any combination thereof.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 10 degrees, 5 degrees, 3 degrees, or 1 degree. As another example, in certain embodiments, the terms “generally perpendicular” and “substantially perpendicular” refer to a value, amount, or characteristic that departs from exactly perpendicular by less than or equal to 10 degrees, 5 degrees, 3 degrees, or 1 degree.

Any terms generally associated with circles, such as “radius” or “radial” or “diameter” or “circumference” or “circumferential” or any derivatives or similar types of terms are intended to be used to designate any corresponding structure in any type of geometry, not just circular structures. For example, “radial” as applied to another geometric structure should be understood to refer to a direction or distance between a location corresponding to a general geometric center of such structure to a perimeter of such structure; “diameter” as applied to another geometric structure should be understood to refer to a cross sectional width of such structure; and “circumference” as applied to another geometric structure should be understood to refer to a perimeter region. Nothing in this specification or drawings should be interpreted to limit these terms to only circles or circular structures.

Any patents and applications and other references noted above, including any that may be listed in accompanying filing papers, are incorporated herein by reference. Aspects of the invention can be modified, if necessary, to employ the systems, functions, and concepts of the various references described above to provide yet further implementations of the invention. These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

To reduce the number of claims, certain aspects of the invention are presented below in certain claim forms, but the applicant contemplates other aspects of the invention in any number of claim forms. Any claims intended to be treated under 35 U.S.C. § 112 (f) will begin with the words “means for,” but use of the term “for” in any other context is not intended to invoke treatment under 35 U.S.C. § 112 (f). Accordingly, the applicant reserves the right to pursue additional claims after filing this application, in either this application or in a continuing application.

1. A method for estimating a value for an environmental heat stress index at a target microscale location, the method comprising:
obtaining meteorological data corresponding to a geographic area associated with the target microscale location, the geographic area being defined so as to include, encompass, or be spatially proximate to at least a portion of a target microscale location, the meteorological data comprising a first wind parameter representative of wind conditions at a first altitude, and cloud cover data indicative of fractional amounts of cloud coverage at multiple atmospheric layers;
receiving user-contributed imagery captured at the target microscale location, the imagery comprising a digital representation of sky conditions and being associated with a time of capture;
obtaining localized terrain data specific to the target microscale location, wherein the localized terrain data comprises at least one of land elevation, land cover, surface roughness, vegetation characteristics, soil composition, soil moisture, thermal properties of surface materials, or structural features of a built environment, and reflects spatial and environmental detail unique to the target microscale location, the localized terrain data comprising a land cover classification from which a surface roughness length is determinable;
performing a bias correction on the meteorological data using the localized terrain data to generate microscale meteorological data, wherein the performing bias correction comprises:
adjusting the first wind parameter to determine a second wind parameter representative of wind conditions at a second altitude that is lower than the first altitude, the second wind parameter being more reflective of near-surface wind conditions at the target microscale location than the first wind parameter,
adjusting the cloud cover data to determine updated fractional cloud coverage values corresponding to the multiple atmospheric layers, the adjusting comprising classifying the user-contributed imagery based at least in part on visual characteristics of the sky conditions, the updated fractional values being more reflective of actual cloud conditions across the multiple atmospheric layers at the target microscale location than the cloud cover data, and
computing a solar radiation parameter based at least in part on the application of optical depth attenuation coefficients specific to respective atmospheric layers to the updated fractional cloud coverage values; and
calculating a value for an environmental heat stress index for the target microscale location based on the microscale meteorological data, wherein the calculating comprises using the second wind parameter, in lieu of the first wind parameter, such that the value represents a quantified measure of heat-related risk specific to the target microscale location.

2. The method of claim 1, wherein the value for the environmental heat stress index is a real-time or near-real-time value for the environmental heat stress index at the target microscale location, wherein the value represents an immediate heat-related risk specific to the target microscale location.

3. (canceled)

4. The method of claim 1, further comprising obtaining an indication of a future time period from a user input, wherein the value for the environmental heat stress index is a forecast value calculated based on the future time period.

5. The method of claim 1, further comprising selecting a first weather monitoring system from a set of weather monitoring systems based on a proximity of the first weather monitoring system to the target microscale location, wherein the meteorological data was obtained by the first weather monitoring system.

6. The method of claim 5, wherein selecting the first weather monitoring system from the set of weather monitoring systems comprises selecting a nearest weather monitoring system of a set of weather monitoring systems to target microscale location.

7. The method of claim 1, wherein the meteorological data is first meteorological data that is not specific to the target microscale location but is representative of a larger geographic area that includes the target microscale location, and wherein the method further comprises obtaining second meteorological data specific to the target microscale location.

8. The method of claim 7, wherein the second meteorological data includes at least one of direct in situ observations, sensor data from handheld or onsite instruments, or imagery depicting current meteorological or environmental conditions at the target microscale location.

9. The method of claim 7, wherein the second meteorological data comprises information relating to cloud cover or sky view factor.

10. The method of claim 1, wherein obtaining the localized terrain data comprises obtaining data from at least one of the following:
a Geographic Information System (GIS) that integrates layers of data representing urban structures, terrain features, or vegetation;
satellite imagery or aerial photography that provide information on land cover or urban development;
topographic maps or surveys conducted by national or regional mapping agencies that detail contours, elevations, or specific landscape features;
environmental sensors deployed in the target microscale location that gather real-time or periodic data on soil conditions, vegetation health, or urban heat islands; or
local observations.

11. The method of claim 1, wherein the environmental heat stress index is Wet Bulb Globe Temperature (WBGT).

12. The method of claim 1, wherein performing the bias correction comprises adjusting the meteorological data to account for differences in atmospheric stratification, moisture content, and surface typologies between the geographic area and the target microscale location, to allow the microscale meteorological data to accurately reflects conditions at the target microscale location.

13. (canceled)

14. The method of claim 1, wherein performing the bias correction comprises determining a solar radiation parameter for the target microscale location based on cloud coverage data from multiple atmospheric levels, wherein calculating the value for the environmental heat stress index for the target microscale location is based on the solar radiation parameter.

15. (canceled)

16. (canceled)

17. The method of claim 1, further comprising presenting the value for the environmental heat stress index within a user interface, configured to notify users of deviations in the environmental heat stress index relative to established thresholds over a defined monitoring period.

18. The method of claim 1, further comprising:
collecting user-contributed data regarding actual environmental conditions at the target microscale location;
wherein the bias correction is further based on the user-contributed data.

19. A system for estimating a personalized value for an environmental heat stress index at a target microscale location, the system comprising:
a processor configured to:
obtain meteorological data corresponding to a geographic area associated with the target microscale location, the geographic area being defined so as to include, encompass, or be spatially proximate to at least a portion of a target microscale location, wherein the target microscale location is defined as a localized area having a maximum spatial extent of up to approximately 20 acres;
obtain localized terrain data for the target microscale location, wherein the localized terrain data comprises at least one of land elevation, land cover, surface roughness, vegetation characteristics, soil composition, soil moisture levels, thermal properties of surface materials, or structural features of a built environment, wherein the localized terrain data corresponds to spatial and environmental detail unique to the target microscale location;
obtain user-contributed physiological data associated with a user at the target microscale location, the user-contributed physiological data comprising at least one of height, weight, age, body mass index, hydration level, heart rate, or information relating to prescription medications;
perform a bias correction on the meteorological data to generate microscale meteorological data based on the localized terrain data, the bias correction dynamically adapting to real-time variations in localized environmental conditions and adjusting for at least one of wind speed, boundary layer mixing, radiative influences, or humidity relevant to the target microscale location; and
calculate a personalized value for an environmental heat stress index for the user at the target microscale location based on the microscale meteorological data and the user-contributed physiological data, wherein the personalized value represents a quantified measure of heat-related risk specific to the user and the target microscale location.

20. A non-transitory computer-readable media comprising computer-executable instructions that, when executed by one or more processors, cause the one or more processors to perform a method for estimating a value for generating and comparing localized environmental heat stress values at multiple target microscale locations to support selection of a location for an activity, the method comprising:
obtaining meteorological data corresponding to a geographic area that includes at least two distinct, non-overlapping target microscale locations, each target microscale location being defined as a localized area having a maximum spatial extent of up to approximately 0.5 acres;
obtaining localized terrain data for each of the target microscale locations, wherein the localized terrain data for each target microscale location comprises at least one of land elevation, land cover, surface roughness, vegetation characteristics, soil composition, soil moisture levels, thermal properties of surface materials, or structural features of a built environment, and reflects spatial and environmental detail unique to the respective target microscale locations;
performing a bias correction on the meteorological data for each of the target microscale locations using corresponding localized terrain data to generate microscale meteorological data, wherein the bias correction dynamically adapts to real-time variations in localized environmental conditions and adjusts for at least one of wind speed, boundary layer mixing, radiative influences, or humidity; and
calculating, for each of the target microscale locations, a respective value for an environmental heat stress index based on the microscale meteorological data, wherein each value quantifies heat-related risk specific to that target microscale location; and
selecting one of the target microscale locations based on a comparison of the respective environmental heat stress index values, wherein the selected target microscale location corresponds to a location having more favorable conditions with respect to heat-related risk.

21. The non-transitory computer-readable medium of claim 20, wherein the method further comprises obtaining physiological data associated with a user, wherein calculating the respective environmental heat stress index value for each of the target microscale locations is based at least in part on the physiological data, and wherein selecting one of the target microscale locations comprises selecting the location having more favorable conditions with respect to heat-related risk as personalized to the physiological characteristics of the user.

22. The method of claim 1, wherein the target microscale location is defined as a localized area having a maximum spatial extent of up to approximately 20 acres.

23. The method of claim 1, wherein the meteorological data comprises:
atmospheric cloud cover indicative of at least one of cloud presence, cloud spatial distribution, cloud density, or cloud type associated with a first region within the geographic area, and
terrain data including at least one of land elevation, land cover, surface roughness, vegetation characteristics, soil composition, soil moisture, or structural features of a built environment associated with a second region within the geographic area.

24. The method of claim 1, further comprising obtaining physiological data associated with a user, wherein calculating the environmental heat stress index value is based at least in part on the physiological data, such that the value is personalized to the physiological characteristics of the user.
